(19) United States
(12) Patent Application Publication
(10) Pub. No.: US 2004/0253384 A1
(43) Pub. Date: Dec. 16, 2004

(54) System and method for coating and sealing structural surfaces

(76) Inventor: C. David Simmons, Mount Airy, NC (US)

Correspondence Address: HITT GAINES P.C., P.O. BOX 832570, RICHARDSON, TX, 75083, US

(21) Appl. No.: 10/458,557

(22) Filed: Jun. 10, 2003

(51) Int. Cl. B05D 1/36

(52) U.S. Cl. 427/402

(57) ABSTRACT

The present invention provides a system and method for coating roadway and driving surfaces which provides better resistance to cracking as well as better surface properties for a smoother riding surface which provides better traction for the wheels or wheeled vehicles traveling across such surface. The surface coating system comprises two separate layers at least the bottom of which includes glass or polymer fibers bonded between two bituminous binder layers with an aggregate dispersed upon the top binder layer. The second or separate layer which is applied atop the first layer is one comprising a polymer modified bituminous composition to which is added a filler and a finely crushed aggregate. The second and top layer is preferably put down upon the first layer immediately following the lay down of such first layer.

### TECHNICAL FIELD OF THE INVENTION

The present invention relates to an improved system for coating roadway and bridge driving surfaces, hereafter referred to as driving surface or driving surfaces, and further, relates to a method for producing such a system. More particularly, the present invention relates to a new and improved driving surface coating system which provides a surface coating having greater resistance to stress cracking, better sealing and wearability characteristics, and additionally which provides better traction for wheeled vehicles moving across such surface, and the method of producing such system.

### BACKGROUND OF THE INVENTION

“Driving surface” as used herein includes highways, bridges, airport runways and taxiways, parking lots and other surfaces comprised of solid cement and/or bituminous structural layers. Such driving surfaces are generally formed of concrete or bituminous materials or combinations of such concrete and bituminous materials. While such materials provide a smooth relatively continuous surface for wheeled vehicles, such surfaces are subject to cracking with an attendant deterioration of such smoothness and continuity of surface. The most commonly identified and accepted causes of cracking are thermal variations and vehicle traffic across the surfaces which result in internal and external stress within and upon the structural layers of the driving surface. The presence of surface cracks in the driving surface makes it possible for water to enter into the body of said driving surface which causes rapid and substantial deterioration and additionally, as noted above, such cracking can result in a loss of the smoothness and continuity of the surface of such driving surface.

To repair cracking of driving surfaces, the most commonly used methods employ the deposition of bituminous compositions over the top and within the cracks. The bituminous compositions are often used in combination with various polymeric materials, aggregates, various fillers, and the like. Though many such polymeric materials have been recognized, among those recognized are such elastomers as polyisoprene, butylrubber, polybutenes, ethylene/vinylacetate polymers/copolymers (EVA), polymethacrylates, polychoroprene, ethylene/propylene/dienes terpolymer (EPDM), polynorbornene, random or block copolymers of styrene and a conjugated diene such as butadiene or isoprene, and the like. Polymers of styrene and a conjugated diene, usually butadiene, in the form of a styrene butadiene rubber latex are often taught as preferred thermoplastic elastomers. Other polymeric materials often recognized as preferred include solvent solutions of EVA.

The bituminous compositions, whether polymer modified or not, are quite frequently used in an emulsified form, the bituminous composition being emulsified in water with the use of various emulsifying agents. The use of the emulsified bitumen compositions allows handling and lay down of the bituminous composition on the driving surface without the need for high temperatures to soften the bituminous composition into a workable mass.

The prior art has taught many other additives for use in the bituminous compositions. These include solid materials such as cement, mineral fillers, sand, aggregate, fibers, and the like. Additionally, many forms of chemical additives have been proposed and used. As noted above, these include but are not limited to various hydrocarbon softening agents, chemicals for stabilizing or breaking of emulsions, and the like.

In the past it has been found that with respect to optimizing usage of bituminous compositions for repairing cracking in the structural layers of driving surfaces, the system of applying the bituminous compositions to the driving surface is very important. As a result, a large number of systems have been developed employing various combinations of mixing and/or layering bituminous compositions, aggregate, cement, various fillers, and the like. Such systems quite frequently are as important if not more important, than the selection of the bituminous composition and additives. In this regard and as an example, it has been proposed to apply a geotextile layer which is defined as a tightly structured textile sheet of natural or synthetic fibers or yarns between layers of a bituminous material (U.S. Pat. No. 5,445,473). As noted, such a geotextile sheet is applied within two or more layers of bituminous binders to add flexibility without breakage to the bituminous materials. It has been further proposed to add aggregates of differing mesh sizes within or upon the bituminous composition and/or the surface of a layer of bituminous composition, when applying such to a driving surface to improve the friction characteristics of the surface of the bituminous material with respect to wheeled traffic thereon, and to provide flexibility to the bituminous materials. Other similar systems have substituted glass fibers for the geotextile layer with similar results. While such systems provide surface coatings having good resistance to cracking of the coating, such systems quite often do not provide the smoothness and surface friction to wheeled vehicles traveling over such coating, as is desired.

Other surface coating systems proposed have employed bituminous emulsions in combination with finely crushed aggregate, a cement/water slurry and a mineral filler to obtain a fast drying, smooth, continuous surface having good traction characteristics in regard to the wheels moving upon and across such surface. However, while providing the good driving surface as far as continuity, smoothness and traction are concerned, this type of surface coating is not as resistant to stress cracking as is desired.

While the prior art bituminous compositions such as those generally discussed above, have been employed in filling cracks and/or the prevention of further cracking and in providing a new crack resistance surface to existing driving surfaces, there is always a need for better such compositions and for better systems employing such compositions while at the same time providing a surface which provides excellent friction with the surface of the wheels of a wheeled vehicle using the driving surface, to improve the traction between such wheels and the surface of the bitumen based surface coating and yet provide a smooth continuous surface for such wheels of wheeled vehicles.

### SUMMARY OF THE INVENTION

The subject of the present invention is therefore a surface coating bituminous based composition, a system and a method for applying such composition and system, for providing a surface coating for driving surfaces which has both excellent resistance to stress cracking and a continuous smooth upper surface providing good traction to wheels of vehicles moving upon the driving surface. The composition and system includes two steps which involve a first or bottom surface coating layer to which is then applied a second or top surface coating layer, all as described below.

The present invention provides a two step system for applying a surface coating which may be applied for the purpose of repairing an already cracked or damaged driving surface or applied to undamaged such surface to protect against such cracking and to improve the surface characteristics in regard to smoothness and traction with respect to wheeled vehicles rolling upon such surfaces. In this two step system, a first or bottom surface coating layer, is applied directly to the structural layer of the driving surface to which is to be applied the complete surface coating system of the present invention. This first surface coating layer is applied by simultaneously and continuously putting down upon such structural layer, a bituminous emulsion binder layer upon which is continuously and concurrently dispersed a non-woven glass or polymeric fiber upon which in turn, is put down a second bituminous emulsion binder layer. The first and second bituminous emulsion layers are preferably the same bituminous emulsion binder composition primarily to minimize handling and/or application problems. However, from a technical standpoint, such first and second bituminous emulsion binder layers may be different compositions so long as each layer is compatible in adhesion with the other binder layer and with the glass or polymeric fibers. Also, concurrently with the laying down of the two bituminous emulsion binder layers with the glass or polymer fiber interspersed therein, a fine aggregate is applied to the upper surface of the second or upper bitumen emulsion binder layer. The application of the aggregate improves the adherence between the first or bottom surface coating layer and the second or top surface coating layer of the second step of the present invention as described below. Additionally, the aggregate stabilizes the bituminous materials upon which it is dispersed. The aggregate also provides an acceptable surface for traffic of wheeled vehicles in the event the second surface coating layer described below is not immediately applied and the first or bottom coating layer must be opened to traffic. Upon completion of the lay down of the first surface coating layer of the present surface coating, the surface coating may be rolled by conventional means providing a new driving surface having excellent resistance to stress cracking and its attendant problems.

The second step of the surface coating system of the present invention preferably comprises covering the first surface coating layer applied as hereinabove described, with a second surface coating layer. This second coating layer preferably is applied promptly following lay down of the first coating layer as above described. However, as noted above, since the first coating layer, if rolled, may be in itself a finished coating layer, such that if circumstances dictate, such first coating layer may be opened to vehicular traffic prior to the application of the second coating layer.

The second surface coating layer is a coating layer comprised of a bituminous emulsion binder composition to which is added a cement, preferably a powdered Portland cement, and a finely crushed aggregate. Most often the binder composition includes a polymer as further discussed below. Additionally, various fibers in the form of polyester, polypropylene or cellulose fiber, may be included. Additionally, mineral fillers and/or additional water, may be added. The mixing of these materials is done concurrently with the spreading of this second surface coating layer upon the above-discussed first surface coating layer of the surface coating system herein defined, such as to have a relatively uniform admixture of such components of the second surface coating layer. The lay down of the second layer of the present surface coating system, may be applied using a distribution system which may be a conventional spray bar or spreader box having as a part thereof, a roller bar and/or screed. Upon lay down of this second layer of the present surface coating system, a finished driving surface is provided having excellent resistance to stress cracking and its attendant problems, as well as a surface providing excellent smoothness and traction with respect to the wheels of vehicles using the driving surface upon which the surface coating system of the present invention has been applied.

With reference to the first surface coating layer, the first step hereinabove described, the first and second bituminous binder layers between which are interspersed the polymer and/or glass fibers, as noted above, may be of the same composition or may be different compositions. These bituminous binder layers, however, generally are a bitumen or from a bitumen modified with polymers. When the bitumen is one modified by a polymer, the polymer will in most cases, be an elastomer such as polyisoprene, butylrubber, polybutene, polyisobutene, ethylene/vinylacetate copolymers (EVA), polymethacrylate, polychoroprene, ethylene/propylene/diene (EPDM) terpolymer, polynorbornene, or random or block copolymers of styrene and of a conjugated diene. These latter copolymers which are random or block copolymers of styrene and of a conjugated diene such as butadiene or isoprene, are particularly effective because they disperse more easily in bitumen emulsions and then impart excellent mechanical and dynamic properties to the bitumen. The preferred polymer used in preparing the polymer modified bitumen of the first step of the present invention is in the form of an SBR latex.

The bitumen employed in the bituminous binder layers usually is a straight run asphalt having a penetration at 25° C. of between 50 and 300 as determined using ASTM D-5. The preferred bitumen is one having such a penetration of between 55 and 200.

When the bituminous binder layer is one in which the bitumen is polymer modified, the amount of polymer generally is used in an amount of within 1.5 to 25 wt. percent of the resulting polymer modified bitumen. Preferably, however, the amount of polymer is such as to be between 2 to 4 wt. % of the resulting bitumen polymer mixture.

In the preferred embodiment of the present invention, the polymer modified bituminous binder layers utilized in the first step of the present invention, are used as an aqueous emulsion of such polymer modified bituminous composition. The emulsification of the polymer modified bituminous binder composition is brought about by any conventional means. The emulsifying agents which may be employed in preparing the polymer modified bituminous binder emulsions of the first step of the present invention, may be any of the emulsifying agents known for such applications. However, generally either cationic or anionic emulsifying agents may be employed with cationic emulsifiers preferably being used. These include such cationic emulsifiers as alkyl amines including quaternary amines and such anioic emulsifiers as a fatty acid combined with sodium hydroxide. The specific preferred commercially available emulsifier may be AKZO NOBEL REDICOTE C-471 or C-450, which may be obtained from AKZO NOBEL Chemicals, Inc. Preparation of the emulsified polymer modified bituminous binder compositions is by conventional means employing the mixing of the polymer modified bitumen with water and the emulsifying agent(s) under high shear agitation. In a preferred embodiment of the present invention, the polymer modified bituminous emulsion is one in which the polymer bitumen residue after distillation (ASTM D244) will have a penetration (ASTM 2397) at 25° C. of 20 to 100, preferably 40 to 90.

In employing a polymer modified bitumen as the binder composition of the first step of the present invention, the bitumen and the polymer may be cross-linked or vulcanized, by using a cross-linking agent or as it is sometimes called, a vulcanization accelerator. Examples of such vulcanization accelerators are elemental sulfur or sulfur containing compounds such as hydrocarbonyl polysulfides, alkylphenol disulfides and disulfides such as morpholine disulfide and N,N′-caprolatam disulfide, mercaptobenzothiazole and its derivatives, or others as mentioned in U.S. Pat. No. 5,605,946, or such compounds as phenolic and phenol-formaldehyde resins as taught in U.S. Pat. No. 5,256,710.

In the use of the polymer modified bitumens in the first step of the present invention, the polymer alone or in combination with the cross-linking agent if used, may be incorporated into the bitumen by any conventional means providing for good mixing. Preferably, however, the polymer is incorporated, by bringing the polymer into contact with the bitumen at a temperature of between 250° and 450° F. and with continuous stirring for a period for several minutes which may be between 1 to 90 minutes to form a homogenous mixture. The cross-linking agent when used and if not added with the polymer, is then added to the mixture thus formed while the stirring is continued, at a temperature of between 250° to 450° F. for at least a time period of 10 to 90 minutes. In this manner, cross-linking of the polymer and the bitumen occurs as well as the bridging of the polymer chains.

With reference to the glass or polymer fibers employed in the first step of the present invention, these are preferably non-woven and if a polymer, preferably consists of a polyester, isotactic polypropylene, polyamide, polyacrylonitrile, cellulose acetate, polyvinylchloride or polyvinylidenechloride. When using glass fibers, such glass fibers are those resulting from the chopping of glass fibers into desired lengths. The non-woven fibers used for best results, are generally of a length of 20 to 200 millimeters (mm.). Preferably, however, the fibers are within the range of 30 to 70 mm. in length. Generally, it is preferred to use glass fibers.

The amount of glass or polymer fibers used can very widely. Advantageously, however, the amount used is such as to result in between 40 and 90 grams of such fiber per square meter of the polymer modified bituminous binder when the polymer modified bituminous binder has been layered onto the structural surface. In applying the fibers, the fibers are uniformly but randomly, dispersed across the area of the first polymer modified bituminous layer. However, in the preferred embodiment of the first step of the present invention, the fibers are used in an amount such as to result in a distribution of 50 to 80 grams per square meter of the surface of the polymer modified bituminous binder.

In regard to the aggregate employed in the first step of the present invention, the aggregate is generally used in an amount necessary to uniformly cover the second or upper bituminous binder layer. The thickness of such aggregate layer on the upper bituminous binder layer normally will be within the range of 3 to 20 mm. Preferably, however, such thickness will be within the range of 3 to 15 mm. The aggregate component may be any of the various hard igneous or metamorphic rock or slag materials or sand, which are commonly used on driving surfaces. Preferably, the aggregate is a crushed stone such as granite, slag, limestone, chat, or the like, or combinations thereof. The preferred aggregate shall be such as to have an aggregate gradation when tested using ASTM C136 and ASTM C117, of one hundred percent passing through a 9.5 mm sieve.

As noted above, in applying the surface coating layer of the first step of the present invention, such first coating layer may be applied to the structural layer of a driving surface by first laying down the first bituminous binder emulsion layer, then dispersing the polymeric or glass fibers on such first or lower binder layer, then applying the second bituminous binder layer atop the glass or polymer fiber impregnated first or lower binder layer and then, applying the aggregate to the top layer. All of these layers will be put down substantially concurrently in a single pass using equipment capable of continuous lay down of each layer upon the other. This may be accomplished using two spray bars with means between the spray bars for introducing the polymeric or glass fibers. In such manner, the lower or bottom layer of bituminous binder is continuously put down on the structural surface from the first spray bar followed by a concurrent and continuous introduction of the fibers upon the bottom layer. The top bituminous layer is concurrently and continuously introduced from the second such spray bar onto the now fiber impregnated bottom layer thereby encapsulating and sealing the fibers within the two polymer modified bituminous binder layers. The aggregate is concurrently and continuously put down atop the second or top polymer modified bituminous layer to complete the lay down of the first surface coating layer which represents the first step of the present invention.

The first step surface coating layer of the present invention will generally be put down to a total thickness within the range of 10 to 25 mm including the aggregate. To accomplish this, the first polymer modified bituminous binder layer emulsion will be put down in an amount such as to form a layer of 2 to 4 mm. in thickness The glass or polymer fibers will be introduced thereon as above described. The second polymer modified bituminous binder emulsion layer, will be applied to the top of the fiber impregnated first or bottom binder layer in an amount such as to result in the above discussed total thickness. Upon application of the aggregate, the total thickness of the total first surface coating layer preferably will be within the range of 10 to 25 mm.

Following completion of the lay down of the first surface coating layer as above discussed, the excess water of the emulsified bituminous composition will break from the emulsion and evaporate. However, if desired, this first surface coating layer may be rolled by conventional means to further smooth the lay down of the first surface coating layer and also, to further exclude the water from the layer. Such rolling also allows the first surface coating layer to be used by wheeled traffic in the event there is a delay between laying down such first surface coating layer and the application of the second surface coating layer. Following the lay down of the aggregate of the first surface coating layer which first surface coating layer is designed as above described to provide a highly stress resistance coating layer, the second surface coating layer preferably is promptly applied as below described.

With respect to providing the second or top surface coating layer which comprises the second step of the present invention, this second or top layer, as noted above, comprises a bituminous composition containing a cement, and a finely crushed aggregate and if and to the extent desired, a fiber and/or mineral filler and/or additional water. This second surface coating layer is prepared using a bituminous emulsion which may comprise either an emulsified bitumen or an emulsified polymer modified bitumen. Use of the polymer modified bitumen represents the preferred embodiment. The bitumen employed in the second surface coating layer of the present invention preferably will be an asphalt having a penetration within the range of 50 to 300 as determined using ASTM Method D-5, and more preferably a penetration of 55 to 200. It is preferred that the asphalt not be a blown asphalt but rather, a straight run asphalt. Bitumen used in the second surface coating layer may be the same or different from those used in the first and/or second bituminous binder layers of the first step of the present invention as hereinabove described.

In utilizing the polymer modified bituminous materials of the second surface coating layer of the present invention, the bituminous material may be physically admixed with the polymer or may be cross-linked with the polymer. The polymers generally may be any of those described above in reference to the polymer modified bitumen binders of the first step of the present invention. However, the polymer preferably used in preparing the polymer modified bitumen of the second step of the present invention, is an SBR latex. The amount of polymer used in the polymer modified bitumen usually will be such as to provide a polymer amount within the range of 2 to 12 wt. % of the polymer/bitumen mixture. Preferably however, the amount of polymer will be in an amount such as to be within the range of 2 to 7 wt. % of the polymer/bitumen mixture. In the preferred embodiment of the present invention, the polymer modified bituminous emulsion is one in which the polymer/bitumen residue after distillation (ASTM D-244) will have a penetration (ASTM 2397) at 25° C. of 20 to 100, preferably 40 to 90.

In the event the polymer modified bitumen is one in which the polymer is cross-linked to the bitumen, the cross-linking of the polymer with the bitumen may be as hereinabove described in reference to the polymer modified bituminous binders used in the first surface coating layer of the present invention. Any of the above discussed cross-linking agents may be used but again, sulfur and sulfur containing compounds such as the mercaptans are preferred. The mixing and the cross-linking of the polymer and the bitumen may be carried out as hereinabove discussed in reference to the polymer modified bituminous binders of the first step surface coating layer of the present invention.

The bituminous material used in the second surface coating layer is preferably used as an emulsion of the bituminous material or polymer modified bituminous material. Preparation of the emulsified bituminous composition for the second surface coating layer may be in accordance with those commonly used and may be within the description of such preparation as provided above in reference to the polymer modified bituminous binders of the first surface coating layer. The specific preparation, however, may be the same or different from the preparation of the first and/or second binder layers of the first surface coating layer.

To the bituminous composition of the second surface coating layer, is added a finely crushed aggregate and if used, cement and water and/or a mineral filler and/or a fiber. The mineral filler when employed, may be selected from the group comprising cement, preferably Portland cement, sand, clays such as bentonite, hydrated lime or calcium carbonate. The preferred mineral filler is Portland cement. The amount of the mineral filler generally will be within the range of 0 to 6% of the weight of the bituminous material, preferably, within the range of 0 to 3% of such bituminous material. When used in the second surface coating layer, the fiber will be one comprising any of the polymeric fibers discussed above in reference to the polymeric fibers which may be used in the first surface coating layer.

To mix the cement when used, with the polymer modified bitumen, the cement preferably is introduced dry into admixture with the bituminous emulsion. The amount of the cement generally will be such as to be within the range of 0 to 3% of the weight of the total composition, preferably, within the range of 1 to 3% of the total composition. Water is controlled to bring the polymer modified bituminous composition content of the emulsified mixture, including aggregate, to approximately 20% to 70% by weight, more especially to within 40% to 70% by weight.

To the second surface coating layer of the present invention may be added an additive capable of controlling the time of break down of the emulsified bituminous composition. Any of those commonly used and taught in the prior art for such time release control, may be employed. Calcium chloride is preferably employed, however.

The bituminous compositions of the second surface coating layer of the present invention along with a cement and aggregate, and if and to the extent desired, a fiber and/or mineral filler and/or additional water are applied upon the first surface coating layer as a continuous surface comprised of a mixture of such components. This preferably is accomplished by mixing the components of the bituminous composition of the second coating layer and introducing such mixture into a conventional spreader box for spreading upon the first coating layer of the present invention. In a preferred embodiment, the components of the second or top surface coating layer are maintained separate from one another until immediately prior to lay down. These components are then brought together and admixed in the lay down equipment. Such equipment provides for a mixing device such as a pug mill, ahead of a standard spreader box with the polymer modified asphalt and the aggregate if and to the extent desired, the mineral filler and/or fibers and/or additional cement and/or additional water being continuously fed into and mixed within the mixing device. If a time release control additive is employed, such also will be separately but continuously fed into and mixed within the mixing device.

In applying the bituminous composition layer which comprises the second or top surface coating layer of the present invention, such layer is applied in a thickness of 5 to 20 mm. such that the total thickness of the two surface coating layer compositions of the present invention shall be within the range of 15 to 72 mm. This thickness includes all aggregate which has been applied.

Following lay down of the second surface coating layer of the present invention, the first and second such coating layers are compacted through rolling by conventional means or through the driving surface traffic itself, to exclude water within the second coating layer and to provide a compressed continuous coating surface having both improved stress resistance and a smooth continuous surface having substantially improved traction. This new surface coating for driving surface combines the features of excellent stress resistance and the feature of excellent surface traction and thereby, provides better braking and anti-skid characteristics and also, provides a very improved, smooth surface.

To more specifically illustrate the present invention, the surface coating of the present invention is applied to a driving surface including both over land and over bridge paving. This driving surface comprises a structural layer of a cementuous pavement. Application of the present system begins with the substantially concurrent and sequential lay down of the elements of a first or bottom surface coating layer. For applying the elements of the first surface coating layer, equipment is used which permits the concurrent but sequential dispensing of the elements of the first surface coating which elements comprise a first bituminous binder layer, a layer of glass fibers upon said first bituminous binder layer, a second bituminous binder layer upon said glass fiber impregnated first bituminous binder layer, followed by the application of a fine aggregate material. The first bituminous binder layer is a polymer modified bituminous composition emulsified in water. The bitumen is one having a penetration of approximately 120 which is polymer modified with an amount of polymer equal to approximately 3% by weight of the bitumen. The polymer is a styrene-butadiene rubber latex. Mixing of the polymer and the bitumen is by any conventional means which results in relatively uniform mixing. The polymer modified bitumen is emulsified by agitation in the presence of water and an emulsifying agent which is a commercially available cationic emulsifier identified as REDICOTE C-450 sold by AKZO NOBEL Chemicals, Inc. Upon the first or bottom bituminous binding layer, chopped glass fibers are uniformly and randomly deposited. The chopped fibers are used in lengths of approximately 40 mm. The glass fibers are distributed uniformly and randomly upon the first or bottom bituminous binder layer in an amount of approximately 60 grams per square meter of surface area of the first bituminous binder layer. The second bituminous binder layer is of the same composition as the first bituminous binder layer discussed above. The aggregate is a crushed granite having a size such that approximately 90% passes through a 4.75 mm sieve.

The components of the first coating layer are introduced into dispensing equipment which has different storage compartments for each of the components. The components are loaded into the storage compartments such that the first bituminous binder layer is dispensed upon the structural surface of the driving surface in an amount approximately 0.8 liters per square meter (1/m²). The chopped glass is concurrently dispersed next in order such that it is layered down and upon the first bituminous binder layer such as to be present upon the first bituminous binder layer in an amount of about 60 grams per square meter (g/m²) with such glass fibers being randomly but uniformly deposited across the surface of said first bituminous binder layer. The second bituminous binder layer is then concurrently dispersed from the equipment such as to be put down upon the chopped glass fibers and the first bituminous layer. The thickness of the lay down of the second bituminous binder layer is also of about 0.8 l/m². The lay down of the second bituminous binder layer seals the glass fibers between and within the joined first and second bituminous binder layers to form a total bituminous binder layer of about 1.6 l/m² having the glass fiber uniformly dispersed therein. The aggregate is concurrently dispersed from the equipment and onto the top bituminous binder layer uniformly and such as that the aggregate layer is substantially 6 millimeter in thickness. These components are concurrently dispersed from the equipment in a sequential fashion as discussed above.

Following the lay down of the first surface coating layer as described above, the second surface coating layer is spread upon the first surface coating layer after approximately 24 hrs. following completion of the lay down of the first surface coating layer. The second surface coating layer is made up of a polymer modified bitumen, cement, aggregate and a mineral filler. The polymer modified bitumen is one prepared from a straight run bitumen having a penetration of about 60 and the polymer is a SBR latex which is used in an amount of about 3% by weight of the total bituminous/polymer mixture. To the bituminous emulsion is added under agitation conditions, cement and water, the amount of cement being such as to represent 3% by weight of the total composition, to provide an emulsion of the polymer modified bitumen and cement. This emulsion is one emulsified using AKZO NOBEL REDICOTE C-471, as the emulsifying agent.

The remaining component of the second surface coating layer, an aggregate is then added. The aggregate used in this example is a crushed granite having a gradation of 100% when graded using a 9.5 mm sieve.

In applying the second or top surface coating layer, the components discussed above are brought together and then mixed in the equipment utilized for the lay down of the second or top surface coating layer on the top of the first or bottom surface coating layer. In such manner, the emulsified polymer modified bitumen and cement containing mixture is continuously dispersed into a pug mill in-line mixing device. Concurrently, the mineral fillers and the aggregate are separately introduced into the in-line mixing device and into contact with the polymer modified bitumen and cement emulsion, the mixing device uniformly admixing the various components which are then fed into a spreader box carried upon the rear of the lay down vehicle. This spreader box uniformly distributes the then mixed second or top surface layer across the first or bottom surface coating layer. The resulting surface coating system following lay down of the top surface layer, is rolled by conventional means to exclude residual water and to compact the different layers of the surface coating system. The surface coating is now uniformly smooth and is found to provide excellent traction to vehicles moving across its surface thereby substantially improving the durability, braking and anti-skid characteristics of the driving surface.

While many surface coating systems exist which provide resistance to stress cracking or which provide smoothness and/or improved friction with wheels traveling across the surface coatings, such systems do not adequately provide both resistance to stress cracking and the smoothness and friction characteristics desired. However, through application of the upper surface layer of the present invention over the lower surface layer of the present invention, not only are the traction, anti-skidding and riding characteristics substantially improved but also through the synergy resulting from combining the two surface coating layers, the resistance to stress cracking of the surface coating is substantially improved.

What is claimed is:

1. A surface coating system for coating and sealing structural surfaces subject to wheeled vehicular traffic comprising:
(a) laying down a first surface coating layer comprising two separate layers of a first bituminous emulsion binder in which individual non-woven fibers selected from the group consisting of glass fibers and polymeric fibers, are interspaced between said two layers of bituminous emulsion binders and to which a uniformly disposed layer of an aggregate material has been applied to the top layer of the bituminous emulsion binders, and
(b) laying down a second surface coating layer applied on top of said first surface coating layer, said second surface coating layer comprising a mixture of a polymer modified bituminous emulsion, cement, an aggregate and a mineral filler, and
(c) rolling the top surface of the second surface coating layer into a finished surface coating having improved resistance to stress cracking and an improved smoothness and traction for wheeled vehicles.

2. The surface coating system of claim 1 wherein the two layers of the first bituminous emulsion binders have the same composition.

3. The surface coating system of claim 1, wherein the composition of the two bituminous emulsion binder layers each comprises a bitumen having a penetration of 55 to 200 and a polymer mixed therewith, said polymer being an SBR latex.

4. The surface coating system of claim 1 wherein the non-woven fiber is a chopped glass fiber.

5. The surface coating system of claim 4 wherein said chopped glass fibers are within the range of 20 to 200 mm in length.

6. The surface coating system of claim 1 wherein the aggregate is one selected from the group comprising crushed granite, slag, limestone, sand or chat.

7. The surface coating system of claim 6 wherein the aggregate is one having a particle size within the range of from 3 to 20 mm in diameter.

8. The surface coating system of claim 1 wherein the polymer modified bituminous emulsion of the second surface coating layer is comprised of a bitumen having a penetration of 55 to 200 and a polymer comprising an SBR latex.

9. The surface coating system of claim 1 wherein the mineral filler of said second surface coating layer is Portland cement.

10. The surface coating system of claim 1 wherein the thickness of each of the two bituminous emulsion binder layers of the first surface coating layer is within the range of 3 to 20 mm.

11. The surface coating system of claim 1 wherein the non-woven fibers of the first surface coating layer are applied in an amount of 40 to 90 grams per square meter of surface of the first bituminous emulsion binder.

12. The surface coating system of claim 1 wherein the thickness of said second surface coating layer is within the range of 5 to 20 mm.

13. The surface coating system of claim 3 wherein the amount of polymer mixed with said bitumen is within the range of 3 to 7 wt. % of said mixture.

14. The surface coating system of claim 8 wherein the amount of said polymer in said polymer modified emulsion is within the range of 3 to 7 wt. % of the polymer/bitumen mixture.

15. The surface coating system of claim 1 wherein the combined thickness of the first coating layer and the second coating layer will be within the range of 15 to 42 mm.

16. The surface coating system of claim 8 wherein the bitumen/polymer residue upon distillation of the polymer modified bituminous emulsion has a penetration of within the range of 20 to 100.

17. A surface coating composition for coating and sealing structural surfaces subject to wheeled vehicular traffic comprising:
(a) a first surface coating layer comprising two separate layers of a first bituminous emulsion binder in which individual non-woven fibers selected from the group consisting of glass fibers and polymeric fibers, are interspaced between said two layers of bituminous emulsion binders and to which a uniformly disposed layer of an aggregate material is applied to the top layer of the bituminous emulsion binders, and
(b) a second surface coating layer applied on top of said first surface coating, said second surface coating comprising a mixture of a polymer modified bituminous emulsion, cement, an aggregate and a mineral filler, and
(c) wherein said first surface coating layer and said second surface coating layer are rolled into a finished surface coating having an improved resistance to stress cracking and an improved smoothness and traction for wheeled vehicles.

18. The surface coating composition of claim 17 wherein the two layers of the first bituminous emulsion binders have the same composition.

19. The surface coating composition of claim 17, wherein the composition of the two bituminous emulsion binder layers each comprises a bitumen having a penetration of 55 to 200, and a polymer mixed therewith, said polymer being one selected from the group comprising SBR latex, EVA, styrene block copolymers of styrene and butadiene or isoprene.

20. The surface coating composition of claim 19 wherein the polymer is an SBR latex.

21. The surface coating composition of claim 17 wherein the non-woven fiber is a chopped glass fiber.

22. The surface coating composition of claim 21 wherein said chopped glass fibers are within the range of 30 to 70 mm in length.

23. The surface coating composition of claim 17 wherein the aggregate is one selected from the group comprising crushed granite, slag, limestone, sand or chat of the types which are commonly used on driving surfaces.

24. The surface coating composition of claim 23 wherein the aggregate is one having a particle size within the range of to 20 mm in average diameter.

25. The surface coating composition of claim 17 wherein the polymer modified bituminous emulsion of the second surface coating layer is comprised of a bitumen having a penetration of 55 to 200 and a polymer comprising an SBR latex.

26. The surface coating composition of claim 17 wherein the mineral filler of said second surface coating layer is Partland cement.

27. The surface coating composition of claim 17 wherein the thickness of each of the two bituminous emulsion binder layers of the first surface coating layer is in the range of 3 to 20 mm.

28. The surface coating composition of claim 17 wherein the non-woven fibers of the first surface coating layer are applied in an amount of 40 to 90 grams per square meter of surface of the first bituminous emulsion binder.

29. The surface coating composition of claim 17 wherein the thickness of said second surface coating layer is within the range of 5 to 20 mm.

30. The surface coating composition of claim 19 wherein the amount of polymer mixed with said bitumen is within the range of 2 to 7 wt. % of said mixture.

31. The surface coating composition of claim 25 wherein the amount of said polymer in said polymer modified emulsion is within the range of 2 to 7 wt. % of the polymer/bitumen mixture.

32. The surface coating composition of claim 17 wherein the combined thickness of the first coating layer and the second coating layer will be within the range of 15 to 72 mm.
